(19) United States
(12) Patent Application Publication
(10) Pub. No.: US 2022/0055520 A1
(43) Pub. Date: Feb. 24, 2022

(54) Cargo Securing Assembly

(71) Applicants: Robert Scott, Joliet, IL (US); Rasharrd Scott, Joliet, IL (US)

(72) Inventors: Robert Scott, Joliet, IL (US); Rasharrd Scott, Joliet, IL (US)

(21) Appl. No.: 16/996,441

(22) Filed: Aug. 18, 2020

(51) Int. Cl. B60P 7/08

(52) U.S. Cl. CPC B60P 7/083; B60P 7/0853

(57) ABSTRACT

A cargo securing assembly includes a bracket is mountable to a cargo trailer. A rod is provided and the rod is rotatably coupled to the bracket. The rod has a slot therein and a cargo strap can be extended therethrough. The rod is rotatable in a first direction to wrap the cargo strap around the rod and a second direction to unwrap the cargo strap from the rod. A nut is coupled to the rod and the nut has a plurality of rectilinear apertures extending therethrough. A pole is provided that has a squared end which is insertable into a respective one of the apertures. Thus, the pole is inhibited from rotating in the respective aperture to inhibit a user from being injured by the pole rotating when the user is tightening the cargo strap.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cargo securing devices and more particularly pertains to a new cargo securing device for PURPOSE.

### (2) Description of Related Art Including Information Disclosed Under 37 CFR 1.97 and 1.98

The prior art relates to cargo securing devices including a cargo strap reel that has a squared cross section. The prior art discloses a variety of ratcheting cargo strap tighteners for tightening a cargo strap on a cargo trailer. The prior art discloses a strap winch that includes a gear and a lock with multiple lobes for engaging teeth on the gear. In no case does the prior art claim a strap tensioner that includes squared holes and a pole with a squared end for inserting into one of the squared holes.

### BRIEF SUMMARY OF THE INVENTION

An embodiment of the disclosure meets the needs presented above by generally comprising a bracket is mountable to a cargo trailer. A rod is provided and the rod is rotatably coupled to the bracket. The rod has a slot therein and a cargo strap can be extended therethrough. The rod is rotatable in a first direction to wrap the cargo strap around the rod and a second direction to unwrap the cargo strap from the rod. A nut is coupled to the rod and the nut has a plurality of rectilinear apertures extending therethrough. A pole is provided that has a squared end which is insertable into a respective one of the apertures. Thus, the pole is inhibited from rotating in the respective aperture to inhibit a user from being injured by the pole rotating when the user is tightening the cargo strap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cargo securing assembly according to an embodiment of the disclosure.

FIG. 2 is a front view of an embodiment of the disclosure.

FIG. 3 is a right side view of an embodiment of the disclosure.

FIG. 4 is a left view phantom of an embodiment of the disclosure.

FIG. 5 is a perspective view of a pole of an embodiment of the disclosure.

FIG. 6 is a right side view of a pole of an embodiment of the disclosure.

FIG. 7 is a top view of pole of an embodiment of the disclosure.

FIG. 8 is a perspective in-use view of an embodiment of the disclosure.

### DETAILED DESCRIPTION OF THE INVENTION

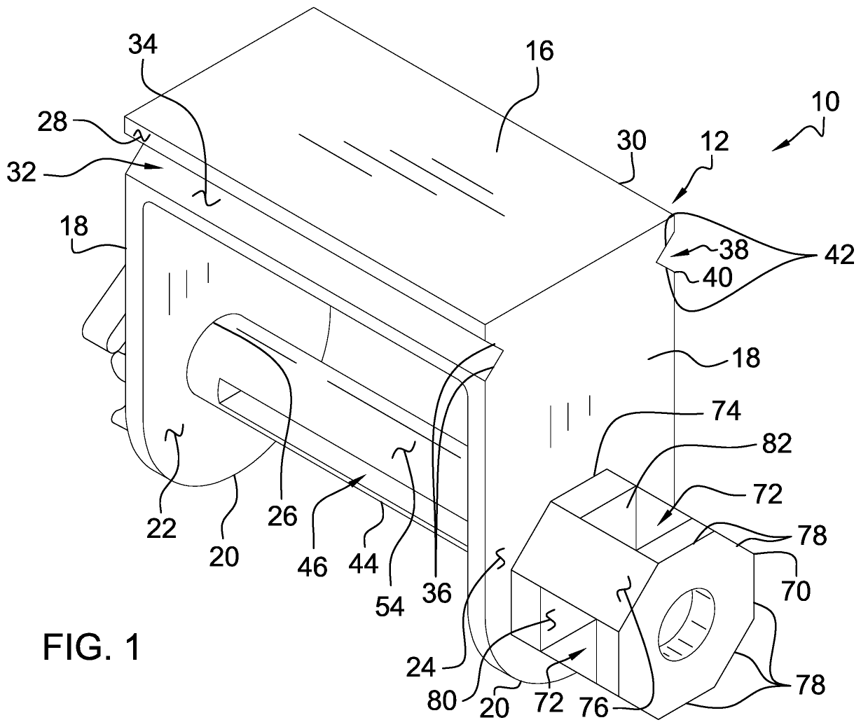

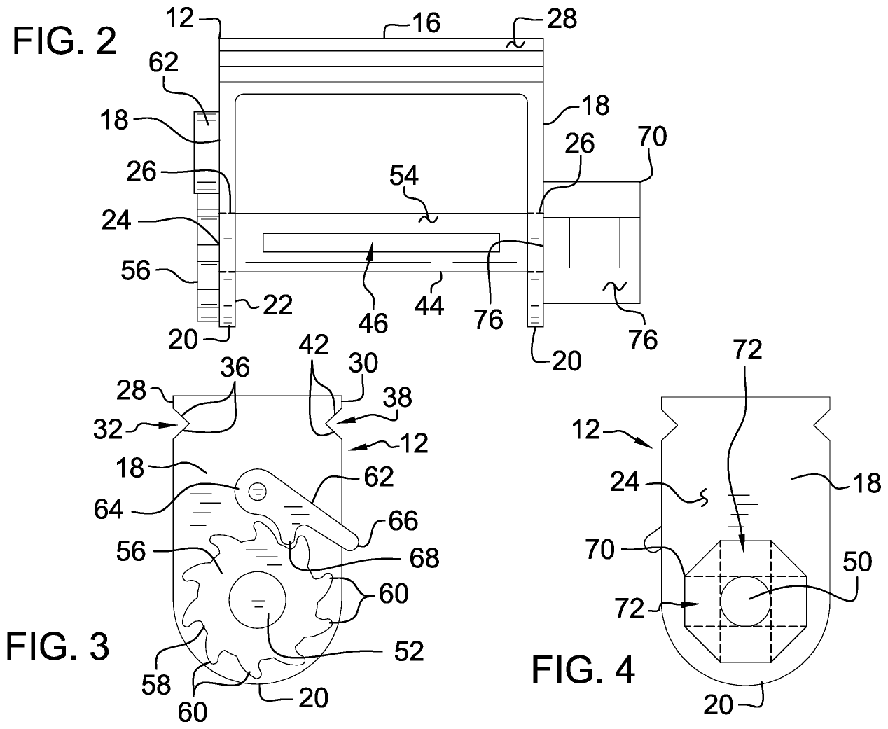

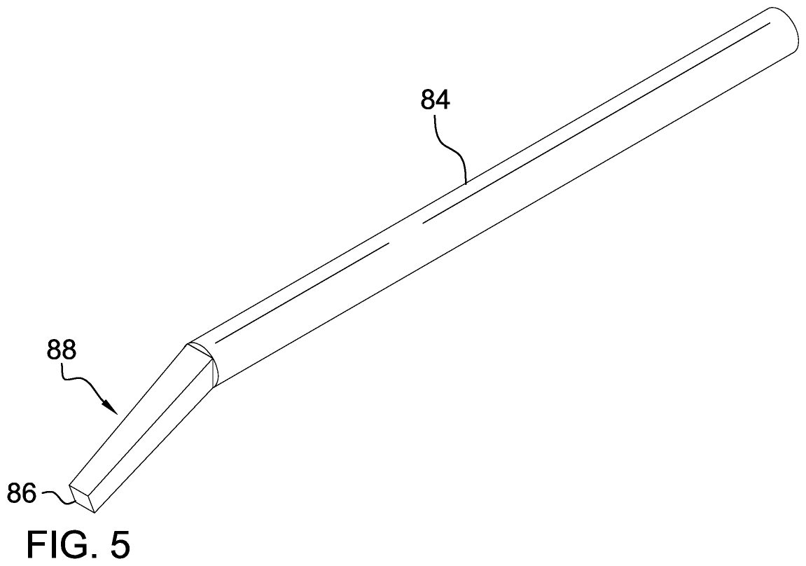

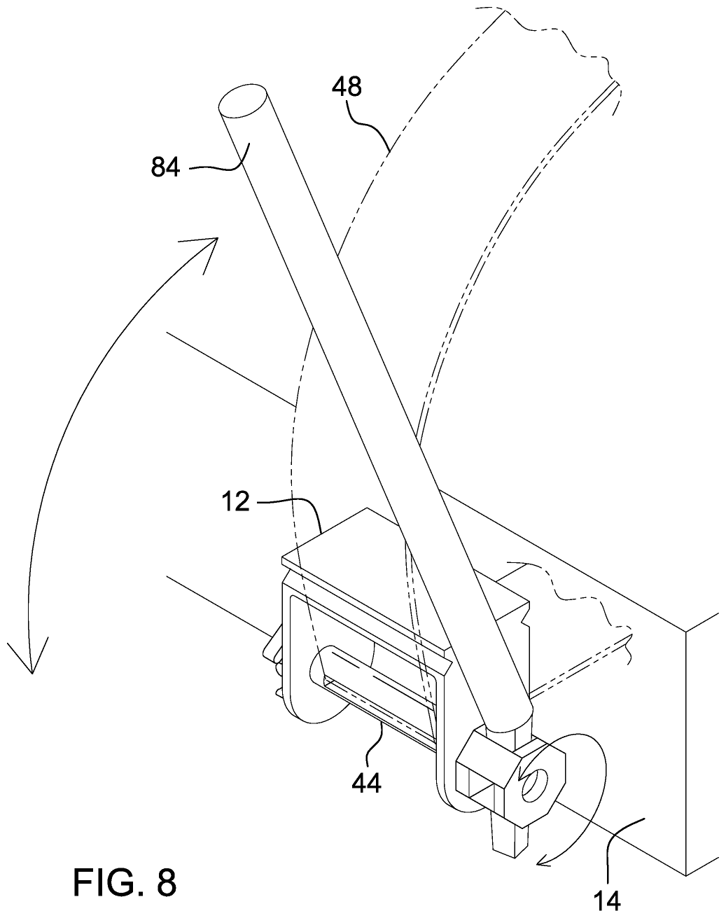

With reference now to the drawings, and in particular to FIGS. 1 through 8 thereof, a new cargo securing device embodying the principles and concepts of an embodiment of the disclosure and generally designated by the reference numeral 10 will be described.

As best illustrated in FIGS. 1 through 8, the cargo securing assembly 10 generally comprises a bracket 12 that is mountable to a cargo trailer 14. The cargo trailer 14 may be a flatbed semi trailer or any other type of cargo trailer 14. The bracket 12 has a central member 16 extending between a pair of outward members 18, and each of the outward members 18 has a distal end 20 with respect to the central member 16. Each of the outward members 18 has an inwardly facing surface 22 and an outwardly facing surface 24, and the inwardly facing surface 22 of each of the outward members 18 faces toward each other. Each of the outward members 18 has a hole 26 extending through the inwardly facing surface 22 and the outwardly facing surface 24. The hole 26 in each of the outward members 18 is positioned adjacent to the distal end 20 of the outward member 18 through which the hole 26 extends.

The central member 16 has a front surface 28 and a back surface 30. The front surface 28 has a first channel 32 extending toward the back surface 30, and the first channel 32 extends between each of the outward members 18. The first channel 32 has a bounding surface 34 and the bounding surface 34 has a pair of sides 36 that intersect at an angle such that the first channel 32 has a triangular shape. The back surface 30 has a second channel 38 extending toward the back surface 30 and the second channel 38 extends between each of the outward members 18. The second channel 38 has a bounding surface 40 and the bounding surface 40 of the second channel 38 has a pair of sides 42 that intersect at an angle such that the second channel 38 has a triangular shape.

A rod 44 is provided and the rod 44 is rotatably coupled to the bracket 12. The rod 44 has a slot 46 therein and the slot 46 insertably receives a cargo strap 48. The rod 44 is rotatable in a first direction to wrap the cargo strap 48 around the rod 44 for tightening the cargo strap 48 over cargo. Additionally, the rod 44 is rotatable in a second direction to unwrap the cargo strap 48 from the rod 44 for loosening the cargo strap 48 on the cargo. The rod 44 has a first end 50, a second end 52 and an outer surface 54 extending therebetween, and the slot 46 extends through the outer surface 54 of the rod 44. The slot 46 is elongated to extend substantially between the first end 50 and the second end 52. Additionally, the rod 44 extends through the hole 26 in each of the outward members 18 of the bracket 12 has the slot 46 is positioned between the outward members 18.

A gear 56 is coupled to the rod 44 and the gear 56 is positioned on the second end 52 of the rod 44. The gear 56 is spaced from the outwardly facing surface 24 of a respective one of the outward members 18. The gear 56 has an outer side 58 comprising a plurality of teeth 60 and the teeth 60 rotate about an axis extending through the first end 50 and the second end 52 of the rod 44 when the rod 44 is rotated. Moreover, each of the teeth 60 is sloped toward the second direction of rotation of the rod 44.

A lock 62 is movably coupled to the bracket 12 and the lock 62 has a primary end 64, a secondary end 66 and a lobe 68 positioned between the primary end 64 and the secondary end 66. The lock 62 is pivotally coupled to the outwardly facing surface 24 of a respective one of the outward members 18 at a point located adjacent to the primary end 64. The lobe 68 is directed toward the gear 56 and the lobe 68 engages the teeth 60 on the gear 56. The lock 62 is biased to engage the gear 56 and the lobe 68 slides over the teeth 60 when the rod 44 is rotated in the first direction thereby facilitating the rod 44 to freely rotate in the first direction. Conversely, the lobe 68 engages the teeth 60 when the rod 44 is rotated in the second direction thereby inhibiting the rod 44 from rotating in the second direction. The lock 62 is urgeable to disengage the gear 56 thereby facilitating the rod 44 to rotate in the second direction.

A nut 70 is provided and the nut 70 is coupled to the rod 44. The nut 70 has a plurality of apertures 72 extending therethrough and each of the apertures 72 has a rectilinear profile. The nut 70 has a first end 74 and an outside surface 76. The outside surface 76 has a plurality of intersecting sides 78 such that the nut 70 has an octagonal cross section taken along a line extending through the first end 50 and the second end 52 of the rod 44. Each of the apertures 72 extends through a respective pair of the intersecting sides 78 of the outside surface 76. Each of the apertures 72 has a bounding surface 80 and the bounding surface 80 of each of the apertures 72 has a plurality of intersecting sides 82 to define the rectilinear profile of the apertures 72.

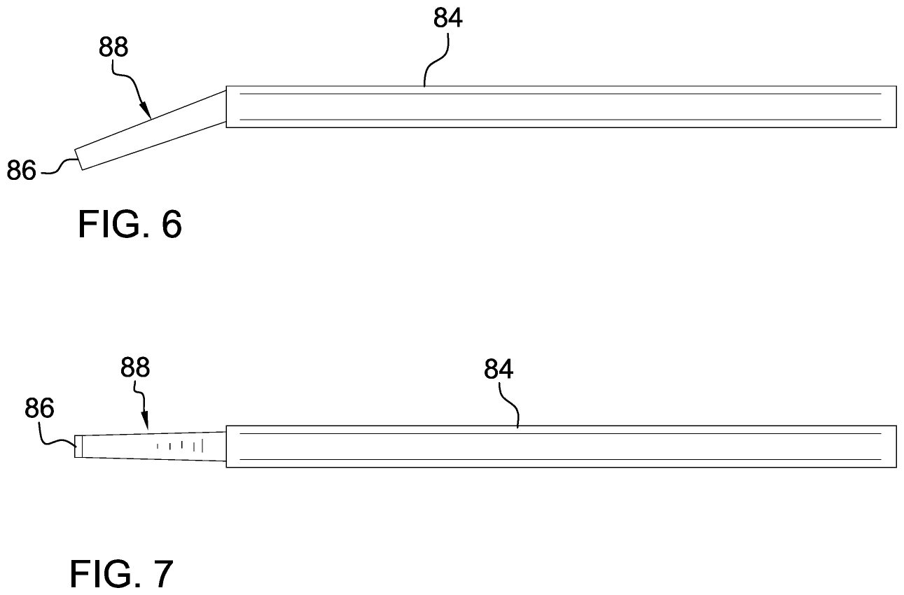

A pole 84 is provided that has a squared end 86 that is insertable into a respective one of the apertures 72 thereby inhibiting the pole 84 from rotating in the respective aperture 72. In this way the rod 44 inhibits a user from being injured from the pole 84 rotating when the user is tightening the cargo strap 48. The pole 84 is oriented perpendicular to the rod 44 when the pole 84 is inserted into the respective aperture 72 to facilitate a mechanical advantage for the user to tighten the cargo strap 48. The pole 84 has an outer surface 86 and the outer surface 86 of the pole 84 has a squared portion 88 that is positioned adjacent to the squared end 86. The squared portion 88 has a plurality of intersecting sides 90 such that the squared portion 88 has a rectilinear shape that conforms to the respective aperture 72. As is most clearly shown in FIGS. 5 and 6, the squared portion 88 may be oriented at an angle with the pole 84 for enhancing the mechanical advantage for the user.

In use, the squared end 86 of the pole 84 is inserted into the respective aperture 72 for rotating the rod 44 to tighten the cargo strap 48 over the cargo. The rectilinear profile of the apertures 72 and the squared end 86 of the pole 84 inhibit the pole 84 from spinning in the nut 70 in the manner of existing cargo strap tensioners. In this way the user is protected from injuries that commonly result from the pole 84 spinning while the user is tightening the cargo strap 48. The lock 62 is urged to disengage the gear 56 to facilitate the cargo strap 48 to be loosened.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cargo securing assembly for tightening a cargo strap over a load on a trailer, said assembly comprising:
a bracket being mountable to a cargo trailer;
a rod being rotatably coupled to said bracket, said rod having a slot therein wherein said slot is configured to have a cargo strap extended therethrough, said rod being rotatable in a first direction wherein said rod is configured to wrap the cargo strap around said rod for tightening the cargo strap over cargo, said rod being rotatable in a second direction wherein said rod is configured to unwrap the cargo strap from said rod for loosening the cargo strap on the cargo;
a nut being coupled to said rod, said nut having a plurality of apertures extending therethrough, each of said apertures having a rectilinear profile; and
a pole having a squared end being insertable into a respective one of said apertures thereby inhibiting said pole from rotating in said respective aperture wherein said rod is configured to inhibit a user from being injured from said pole rotating when the user is tightening the cargo strap, said pole being oriented perpendicular to said rod when said pole is inserted into said respective aperture wherein said pole is configured to facilitate a mechanical advantage for the user to tighten the cargo strap.

2. The assembly according to claim 1, wherein said bracket has a central member extending between a pair of outward members, each of said outward members having a distal end with respect to said central member, each of said outward members having an inwardly facing surface and an outwardly facing surface, said inwardly facing surface of each of said outward members facing toward each other.

3. The assembly according to claim 2, wherein each of said outward members has a hole extending through said inwardly facing surface and said outwardly facing surface, said hole in each of said outward members being positioned adjacent to said distal end of said outward member through which said hole extends.

4. The assembly according to claim 2, wherein said central member has a front surface and a back surface, said front surface having a first channel extending toward said back surface, said first channel extending between each of said outward members, said first channel having a bounding surface, said bounding surface having a pair of sides that intersect at an angle such that said first channel has a triangular shape.

5. The assembly according to claim 4, wherein said back surface has a second channel extending toward said back surface, said second channel extending between each of said outward members, said second channel having a bounding surface, said bounding surface of said second channel having a pair of sides that intersect at an angle such that said second channel has a triangular shape.

6. The assembly according to claim 3, wherein said rod has a first end, a second end and an outer surface extending therebetween, said slot extending through said outer surface of said rod, said slot being elongated to extend substantially between said first end and said second end, said rod extending through said hole in each of said outward members of said bracket having said slot being positioned between said outward members.

7. The assembly according to claim 6, further comprising a gear being coupled to said rod, said gear is positioned on said second end of said rod having said gear being spaced from said outwardly facing surface of a respective one of said outward members, said gear having an outer surface comprising a plurality of teeth, said teeth rotating about an axis extending through said first end and said second end of said rod when said rod is rotated, each of said teeth being sloped toward said second direction of rotation of said rod.

8. The assembly according to claim 7, further comprising a lock being movably coupled to said bracket, said lock having a primary end, a secondary end and a lobe positioned between said primary end and said secondary end, said lock being pivotally coupled to said outwardly facing surface of a respective one of said outward members at a point located adjacent to said primary end, said lobe being directed toward said gear, said lobe engaging respective teeth on said gear, said lock being biased to engage said gear.

9. The assembly according to claim 8, wherein said lobe slides over said teeth when the rod is rotated in said first direction thereby said rod to freely rotate in said first direction, said lobe engaging said teeth when said rod is rotated in said second direction thereby inhibiting said rod from rotating in said second direction, said lock being urgeable to disengage said gear thereby facilitating said rod to rotate in said second direction.

10. The assembly according to claim 6, wherein said nut has a first end and an outside surface, said outside surface having a plurality of intersecting sides such that said nut has an octagonal cross section taken along a line extending through said first end and said second end of said rod, each of said apertures extending through a respective pair of said intersecting sides of said outside surface, each of said apertures having a bounding surface, said bounding surface of each of said apertures having a plurality of intersecting sides to define said rectilinear profile.

11. The assembly according to claim 1, wherein said pole has an outer surface, said outer surface of said pole having a squared portion being positioned adjacent to said squared end, said squared portion having a plurality of intersecting sides such that said squared portion has a rectilinear shape that conforms to said respective aperture.

12. A cargo securing assembly for tightening a cargo strap over a load on a trailer, said assembly comprising:
a bracket being mountable to a cargo trailer, said bracket having a central member extending between a pair of outward members, each of said outward members having a distal end with respect to said central member, each of said outward members having an inwardly facing surface and an outwardly facing surface, said inwardly facing surface of each of said outward members facing toward each other, each of said outward members having a hole extending through said inwardly facing surface and said outwardly facing surface, said hole in each of said outward members being positioned adjacent to said distal end of said outward member through which said hole extends, said central member having a front surface and a back surface, said front surface having a first channel extending toward said back surface, said first channel extending between each of said outward members, said first channel having a bounding surface, said bounding surface having a pair of sides that intersect at an angle such that said first channel has a triangular shape, said back surface having a second channel extending toward said back surface, said second channel extending between each of said outward members, said second channel having a bounding surface, said bounding surface of said second channel having a pair of sides that intersect at an angle such that said second channel has a triangular shape;
a rod being rotatably coupled to said bracket, said rod having a slot therein wherein said slot is configured to have a cargo strap extended therethrough, said rod being rotatable in a first direction wherein said rod is configured to wrap the cargo strap around said rod for tightening the cargo strap over cargo, said rod being rotatable in a second direction wherein said rod is configured to unwrap the cargo strap from said rod for loosening the cargo strap on the cargo, said rod having a first end, a second end and an outer surface extending therebetween, said slot extending through said outer surface of said rod, said slot being elongated to extend substantially between said first end and said second end, said rod extending through said hole in each of said outward members of said bracket having said slot being positioned between said outward members;
a gear being coupled to said rod, said gear being positioned on said second end of said rod having said gear being spaced from said outwardly facing surface of a respective one of said outward members, said gear having an outer surface comprising a plurality of teeth, said teeth rotating about an axis extending through said first end and said second end of said rod when said rod is rotated, each of said teeth being sloped toward said second direction of rotation of said rod;
a lock being movably coupled to said bracket, said lock having a primary end, a secondary end and a lobe positioned between said primary end and said secondary end, said lock being pivotally coupled to said outwardly facing surface of a respective one of said outward members at a point located adjacent to said primary end, said lobe being directed toward said gear, said lobe engaging respective teeth on said gear, said lock being biased to engage said gear, said lobe sliding over said teeth when the rod is rotated in said first direction thereby said rod to freely rotate in said first direction, said lobe engaging said teeth when said rod is rotated in said second direction thereby inhibiting said rod from rotating in said second direction, said lock being urgeable to disengage said gear thereby facilitating said rod to rotate in said second direction;
a nut being coupled to said rod, said nut having a plurality of apertures extending therethrough, each of said apertures having a rectilinear profile, said nut having a first end and an outside surface, said outside surface having a plurality of intersecting sides such that said nut has an octagonal cross section taken along a line extending through said first end and said second end of said rod, each of said apertures extending through a respective pair of said intersecting sides of said outside surface, each of said apertures having a bounding surface, said bounding surface of each of said apertures having a plurality of intersecting sides to define said rectilinear profile; and
a pole having a squared end being insertable into a respective one of said apertures thereby inhibiting said pole from rotating in said respective aperture wherein said rod is configured to inhibit a user from being injured from said pole rotating when the user is tightening the cargo strap, said pole being oriented perpendicular to said rod when said pole is inserted into said respective aperture wherein said pole is configured to facilitate a mechanical advantage for the user to tighten the cargo strap, said pole having an outer surface, said outer surface of said pole having a squared portion being positioned adjacent to said squared end, said squared portion having a plurality of intersecting sides such that said squared portion has a rectilinear shape that conforms to said respective aperture.
